(19) United States
(12) Patent Application Publication
(10) Pub. No.: US 2015/0229737 A1
(43) Pub. Date: Aug. 13, 2015

(54) COMMUNICATION DEVICE, COMMUNICATION METHOD, AND TERMINAL DEVICE

(71) Applicant: Kabushiki Kaisha Toshiba, Minato-ku (JP)

(72) Inventors: Yuichiro OYAMA, Meguro (JP); Takeshi ISHIHARA, Yokohama (JP); Hiroshi NISHIMOTO, Yokohama (JP)

(73) Assignee: Kabushiki Kaisha Toshiba, Minato-ku (JP)

(21) Appl. No.: 14/567,022

(22) Filed: Dec. 11, 2014

(30) Foreign Application Priority Data
Feb. 13, 2014 (JP) 2014-025675

(51) Int. Cl. H04L 29/08

(52) U.S. Cl. CPC H04L 67/32; H04L 67/02

(57) ABSTRACT

According to an embodiment, a communication device includes a receiving unit, an obtaining unit, and a transfer unit. The receiving unit receives acquisition information, which is sent from a general-purpose processor to a network and which represents information for obtaining data present on the network. Based on the received acquisition information, the obtaining unit obtains the data on behalf o the general-purpose processor. When processing unit data representing the data to be used in units of processing by the general-purpose processor is obtained, the transfer unit transfers the obtained processing unit data to the general-purpose processor.

### CROSS-REFERENCE TO RELATED APPLICATIONS

This application is based upon and claims the benefit o priority from Japanese Patent Application No. 2014-025675, filed on Feb. 13, 2014; the entire contents of which are incorporated herein by reference.

### FIELD

Embodiments described herein relate generally to a communication device, a communication method, and a terminal device.

### BACKGROUND

Conventionally, a technology is known in which, while a terminal device is performing a Web access, the data required in configuring the entire Web page is obtained on behalf of a processor. For example, when the processor issues an acquisition request for the entire Web page, there is a function by which the data required in configuring the entire Web page is obtained independently of the processor. As a result, while the data required in configuring the entire Web page is being obtained, the processor can switch to a sleep state.

However, in the conventional technology, there is a possibility that the user friendliness undergoes a decline. For example, in the conventional technology, in the case when the data required in configuring the entire Web page is large in size or when the radio wave environment is poor, it leads to an increase in the processing load of the processor thereby likely requiring substantial time to display the Web page. As a result, in the conventional technology, there occurs an increase in the period of time for which the Web page is not updated, thereby leading to a decline in the user friendliness.

### BRIEF DESCRIPTION OF THE DRAWINGS

FIG. 1 is a diagram illustrating a configuration of a communication system according to a first embodiment;

FIG. 2 is a sequence diagram illustrating a data acquisition process according to the first embodiment;

FIG. 3 is a block diagram illustrating a hardware configuration of a terminal device according to the first embodiment;

FIG. 4 is a block diagram illustrating a functional configuration of the terminal device according to the first embodiment;

FIG. 5 is a flowchart for explaining a sequence of processes performed in a communication device according to the first embodiment;

FIG. 6 is a block diagram illustrating a functional configuration of a terminal device according to a second embodiment;

FIG. 7 is a flowchart for explaining a sequence of processes performed in a communication device according to the second embodiment;

FIG. 8 is a block diagram illustrating a functional configuration of a terminal device according to a third embodiment; and

FIG. 9 is a flowchart for explaining a sequence of processes performed in a communication device according to the third embodiment.

### DETAILED DESCRIPTION

According to an embodiment, a communication device includes a receiving unit, an obtaining unit, and a transfer unit. The receiving unit receives acquisition information, which is sent from a general-purpose processor to a network and which represents information for obtaining data present on the network. Based on the received acquisition information, the obtaining unit obtains the data on behalf of the general-purpose processor. When processing unit data representing the data to be used in units of processing by the general-purpose processor is obtained, the transfer unit transfers the obtained processing unit data to the general-purpose processor.

### First Embodiment

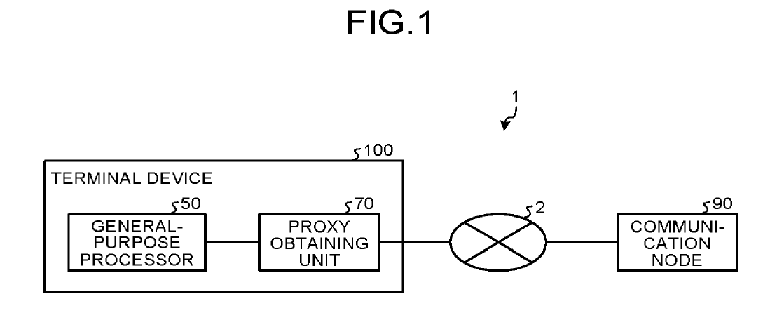

FIG. 1 is a diagram illustrating an exemplary configuration of a communication system according to a first embodiment. As illustrated in FIG. 1, a communication system 1 includes a terminal device 100 and a communication node 90 that are connected to a network 2 such as the Internet or a local area network (LAN). Herein, the communication via the network 2 can be implemented either in a wireless manner or in a wired manner. Moreover, the communication system 1 can include a plurality of terminal devices 100 and a plurality of communication nodes 90.

The communication node 90 is an information processing device such as a server. When the Internet serves as the network 2, the communication node 90 can function as a Web server. The communication node 90 holds a variety of data that is used during the processing performed in the terminal device 100, and sends data in response to a request issued by the terminal device 100.

The terminal device 100 includes a general-purpose processor 50 and a proxy obtaining unit 70. Herein, the terminal device 100 is, for example, an information processing device such as a PC; or a smartphone; or a tablet terminal. The general-purpose processor 50 performs general-purpose data processing. For example, the general-purpose processor 50 includes a central processing unit (CPU), a random access memory (RAM), and a read only memory (ROM). The RAM is used as a work memory while running an operating system (OS) or computer programs such as application software. The general-purpose processor 50 sends, to the communication node 90, an acquisition request for the data to be used in the data processing. Moreover, upon sending a data acquisition request, the general-purpose processor 50 switches to the sleep mode, which is the operating mode having a reduced power consumption.

The proxy obtaining unit 70 obtains, on behalf of the general-purpose processor 50, the data to be used in the data processing performed by the general-purpose processor 50. For example, the proxy obtaining unit 7C receives an acquisition request sent by the general-purpose processor 50 to the communication node 90, and then issues an acquisition request to the communication node 90 on behalf of the general-purpose processor 50. Then, the proxy obtaining unit 70 obtains the data sent by the communication node 90 in response to the acquisition request. Thereafter, when processing unit data that represents the data to be used in units of processing by the general-purpose processor 50 is obtained, the proxy obtaining unit 70 transfers the processing unit data to the general-purpose processor 50. When transferring the processing unit data, the proxy obtaining unit 70 also issues an activation instruction for activating the general-purpose processor 50 that has switched to the sleep mode.

Upon receiving the processing unit data transferred by the proxy obtaining unit 70, the general-purpose processor 50 switches back from the sleep mode and performs data processing based on the processing unit data. After performing the data processing, the general-purpose processor 50 again switches to the sleep mode until next piece of processing unit data is transferred thereto. Thus, in the first embodiment, while the proxy obtaining unit 70 is obtaining the data, the general-purpose processor 50 is switched to the sleep mode thereby enabling achieving electrical power saving. Besides, in the first embodiment, when processing unit data is obtained, it is transferred to the general-purpose processor 50 for the purpose of data processing. That enables achieving reduction in the processing load and, for example, enables holding down an increase in the period of time for which the Web page is not updated. Hence, it becomes possible to enhance the user friendliness.

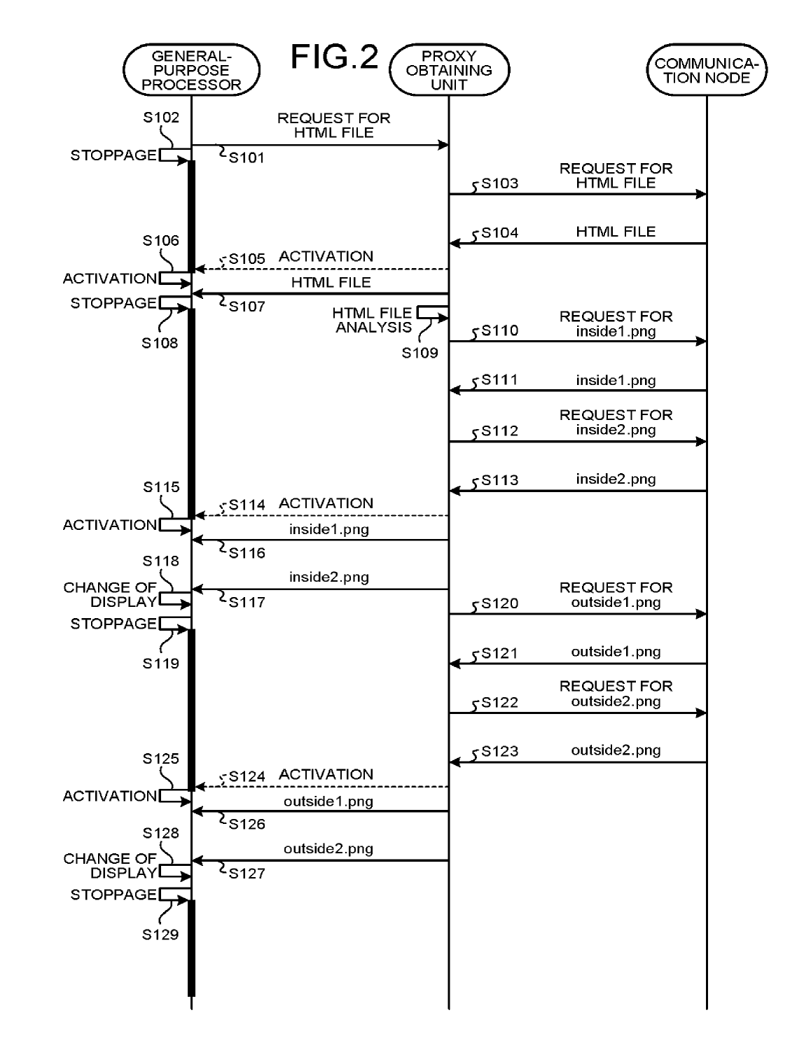

FIG. 2 is a sequence diagram illustrating an example of a data acquisition process according to the first embodiment. With reference to FIG. 2, the explanation is given for an example of the data acquisition process in which data required in updating a browser application of the terminal device 100 is obtained from the communication node 90 serving as a Web server. That is, updating of a browser application is an application software operation that triggers the general-purpose processor 50 to perform the data acquisition process with respect to the communication node 90.

For example, the data that is requested by the general-purpose processor 50 to the communication node 90 is in the form of a file such as an HTML file (HTML stands for HyperText Markup Language) constituting a Web page, and corresponds to a file including a data-acquisition-method identifier (described later). Herein, a data-acquisition-method identifier corresponds to, for example, a uniform resource locator (URL) that indicates the location and the acquisition method of a resource such as an HTML file present on the Internet.

As illustrated in FIG. 2, in the case in which the data held by the communication node 90 is to be used in a browser application, the general-purpose processor 50 sends an HTML file acquisition request and a data-acquisition-method identifier indicating the acquisition method for data from the communication node 90 (Step S101). In addition, the general-purpose processor 50 can also send storage information that contains the method for storing the data obtained in response to the acquisition request. Then, the general-purpose processor 50 switches to the sleep (stoppage) mode (Step S102). In FIG. 2, heavy lines are used to indicate that the general-purpose processor 50 is in the sleep mode.

Then, the proxy obtaining unit 70 receives the HTML file acquisition request and the data-acquisition-method identifier, and starts issuing an acquisition request for data to the communication node 90 via the network 2. For example, the proxy obtaining unit 70 requests the communication node 90 to send an HTML file (Step S103). In response, the communication node sends the requested HTML file to the proxy obtaining unit 70 (Step S104).

Upon receiving the HTML file, the proxy obtaining unit 70 issues an activation instruction to the general-purpose processor 50 (Step S105). In response, the general-purpose processor 50 switches back to the active state from the sleep mode (Step S106). Moreover, the proxy obtaining unit 70 transfers the obtained HTML file to the general-purpose processor 50 (Step S107). Thus, the general-purpose processor 50 receives the HTML file. Subsequently, the general-purpose processor 50 again switches to the sleep mode (Step S108).

Meanwhile, the proxy obtaining unit 70 analyzes the received HTML file and extracts the data-acquisition-method identifier embedded in the HTML file (Step S109). Herein, there is a possibility that a plurality of data-acquisition-method identifiers is embedded in the HTML file. Thus, the proxy obtaining unit 70 extracts all data-acquisition-method identifiers embedded in the HTML file. Then, the proxy obtaining unit 70 obtains data based on the extracted data-acquisition-method identifiers.

As an example, consider a case in which an HTML file, an inside1.png file, an inside2.png file, an outside1.png file, as well as an outside2.png file represents the processing unit data mentioned above. Moreover, assume that the HTML file contains the data-acquisition-method identifiers of the inside1.png file, the inside2.png file, the outside1.png file, and the outside2.png file. In this case, the proxy obtaining unit 70 requests the communication node 90 to send the inside1.png file (Step S110). In response to that request, the communication node 90 sends the inside1.png file to the proxy obtaining unit 70 (Step S111). Then, the proxy obtaining unit 70 requests the communication node 90 to send the inside2.png file (Step S112). In response to that request, the communication node 90 sends the inside2.png file to the proxy obtaining unit 70 (Step S113).

Upon obtaining such processing unit data, the proxy obtaining unit 70 issues an activation instruction to the general-purpose processor 50 (Step S114). In response, the general-purpose processor 50 switches back to the active state from the, sleep mode (Step S115). Moreover, the proxy obtaining unit 70 transfers the inside1.png file and the inside2.png file to the general-purpose processor 50 (Step S116 and Step S117). Thus, the general-purpose processor 50 receives the processing unit data (the inside1.png file and the inside2.png file). Subsequently, based on the processing unit data, the general-purpose processor 50 updates the browser application and changes the display (Step S118). Then, the general-purpose processor 50 again switches to the sleep mode (Step S119).

The proxy obtaining unit 70 then requests the communication node 90 to send the outside1.png file (Step S120). In response to that request, the communication node 90 sends the outside1.png file to the proxy obtaining unit 70 (Step S121). Moreover, the proxy obtaining unit 70 requests the communication node 90 to send the outside2.png file (Step S122). In response to that request, the communication node 90 sends the outside2.png file to the proxy obtaining unit 70 (Step S123). Herein, the set of the outside1.png file and the outside2.png is an example of the processing unit data.

Upon obtaining such processing unit data, the proxy obtaining unit 70 issues an activation instruction to the general-purpose processor 50 (Step S124). In response, the general-purpose processor 50 switches back to the active state from the sleep mode (Step S125). Moreover, the proxy obtaining unit 70 transfers the outside1.png file and the outside2.png file to the general-purpose processor 50 (Step S126 and Step S127). Thus, the general-purpose processor 50 receives the processing unit data (the cutside1.png file and the outside2.png file). Subsequently, based on the processing unit data, the general-purpose processor 50 updates the browser application and changes the display (Step S128). Then, the general-purpose processor 50 again switches to the sleep mode (Step S129).

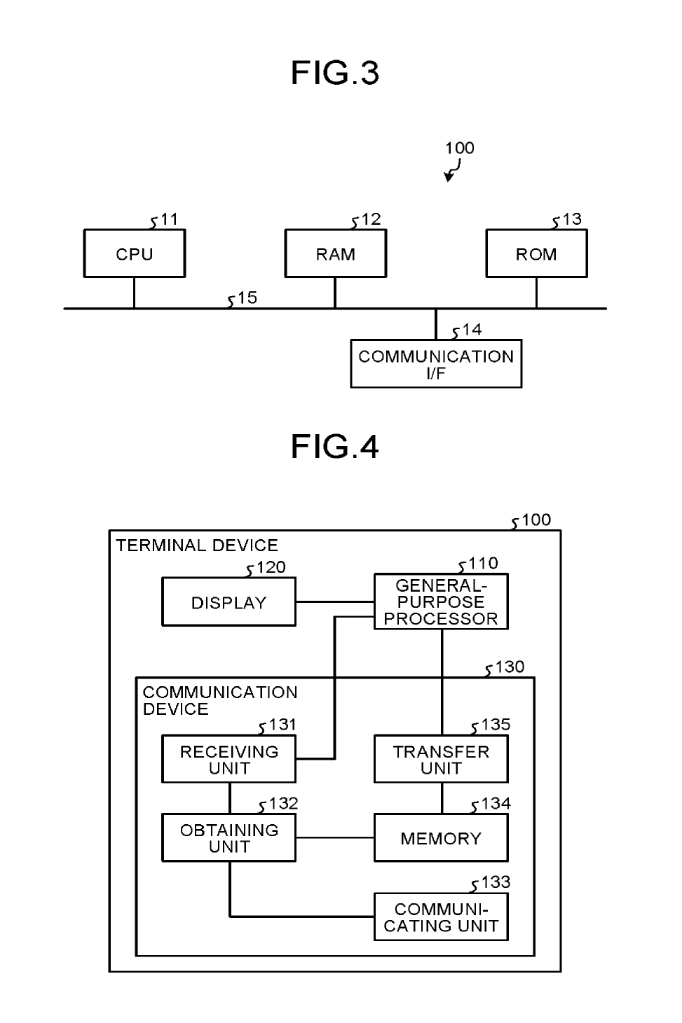

FIG. 3 is a block diagram illustrating an exemplary hardware configuration of the terminal device 100 according to the first embodiment. As illustrated in FIG. 3, the terminal device 100 includes a CPU 11, a RAM 12, a ROM 13, and a communication I/F 14 that are connected to each other by a bus 15.

The CPU 11 performs the overall control of the terminal device 100. The RAM 12 is used to temporarily store the data to be used in the processing performed under the control of the CPU 11. The ROM 13 is used to store computer programs and a variety of data to be used in the processing performed under the control of the CPU 11. The communication I/F 14 performs communication with an external device such as the communication node 90. Meanwhile, for example, the CPU 11 is equipped with the function of the general-purpose processor 50. Moreover, for example, the communication I/F 14 is equipped with the function of the proxy obtaining unit 70.

FIG. 4 is a block diagram illustrating an exemplary functional configuration of the terminal device 100 according to the first embodiment. As illustrated in FIG. 4, the terminal device 100 includes a general-purpose processor 110, a display 120, and a communication device 130. Moreover, the communication device 130 further includes a receiving unit 131, an obtaining unit 132, a communicating unit 133, a memory 134, and a transfer unit 135. Some or all of these constituent elements can be implemented using software (computer programs) or can be implemented using hardware circuitry. Meanwhile, the general-purpose processor 110 is an example of the general-purpose processor 50. Similarly, the communication device 130 is an example of the proxy obtaining unit 70.

The general-purpose processor 110 performs general-purpose data processing. More particularly, the general-purpose processor 110 outputs acquisition information that indicates the information required in obtaining the data used in the data processing. The acquisition information contains an acquisition request for the data used in the data processing; a data-acquisition-method identifier indicating the method of data acquisition; and storage information containing the method of storing the data obtained in response to an acquisition request. When data is obtained, the general-purpose processor 110 performs data processing. Herein, the obtained data represents the processing unit data used in units of processing. For example, the data processing is performed to update (to change the display of) a browser application displayed on the display 120. Thus, based on the processing unit data that is arbitrarily obtained, the general-purpose processor 110 updates the browser application. Meanwhile, after outputting the obtained information or after performing the data processing, the general-purpose processor 110 switches to the sleep mode. Then, at the time of obtaining processing unit data, the general-purpose processor 110 returns from the sleep mode to perform the data processing.

For example, a user starts the browser application in the terminal device 100 and inputs, as a data-acquisition-method identifier, the URL of the intended HTML file either by selecting the URL from the bookmarks or by directly specifying the URL. Then, the general-purpose processor 110 sends, to the network 2, an acquisition request for the HTML file indicated by the data-acquisition-method identifier, along with the data-acquisition-method identifier. In the first embodiment, the acquisition request and the data-acquisition-method identifier that are sent by the general-purpose processor 110 are received by the obtaining unit 132.

The display 120 displays a variety of information under the control of the general-purpose processor 110. For example, after the general-purpose processor 110 updates the browser application, the display 120 displays the updated browser application.

The receiving unit 131 receives acquisition information. More particularly, the receiving unit 131 receives the acquisition information output by the general-purpose processor 110. Then, the receiving unit 131 outputs the received acquisition information to the obtaining unit 132.

The obtaining unit 132 obtains data based on the acquisition information. More particularly, the obtaining unit 132 obtains, based on the acquisition request and the data-acquisition-method identifier included in the acquisition information output by the receiving unit 131, data from the communication node 90 on behalf of the general-purpose processor 110. The communication node 90 sends, to the terminal device 100, the data indicated by the data-acquisition-method identifier. For example, if the communication node 90 is a Web server on the Internet, then the communication node 90 sends contents data as a Web page made of HTML files. Meanwhile, a Web page may contain a variety of contents data such as image data and moving-image data in some cases. Moreover, the communication with the communication node 90 is performed via the communicating unit 133. The obtaining unit 132 performs a data acquisition process according to the data-acquisition-method identifier embedded in the obtained data. For example, the obtaining unit 132 issues a data acquisition request according to the extracted data-acquisition-method identifier, and stores the obtained data in the memory 134.

More specifically, upon receiving an HTML file, the obtaining unit 132 analyzes the HTML file and extracts the data-acquisition-method identifiers from the HTML file. For example, the obtaining unit 132 deciphers the contents of the HTML file and searches for tags such as “img src”, “body background”, and “object data” in which the data-acquisition-method identifiers are embedded. Then, the obtaining unit 132 extracts the data-acquisition-method identifiers embedded in the tags. Meanwhile, the types of the tags are not limited to the types mentioned herein.

Then, with respect to each extracted data-acquisition-method identifier, the obtaining unit 132 performs the data acquisition process. That is, when a plurality of data-acquisition-method identifiers is extracted, the data acquisition process is repeated for the number of times equal to the number of data-acquisition-method identifiers. The sequence of performing the data acquisition processes can be decided based on the sequence in which the data-acquisition-method identifiers are written. Alternatively, the sequence of performing the data acquisition processes can be decided based on the degrees of similarity between the host names or the domain names of data, the URLs, and the data-acquisition-method identifiers. Still alternatively, the sequence of performing the data acquisition processes can be decided depending on the types of data.

Explained below is a specific example of the sequence of performing the data acquisition processes. Firstly, the obtaining unit 132 groups the files that are used for the display purposes by the display 120 as a group having high priority. Then, the obtaining unit 132 groups the not-yet-grouped data-acquisition-method identifiers on a domain-by-domain basis. Subsequently, depending on the degrees of similarity between the domain names of HTML files and the data-acquisition-method identifiers, the obtaining unit 132 performs ordering of the groups. Moreover, in each group, the ordering of files is done in the sequence of HTML files, CSS files, script files, and other files. If there are files having the same file type, then the ordering is done based on the display positions. For example, a file to be displayed closer to the center of the screen is given priority. Meanwhile, the sequence of performing the data acquisition processes is not limited to the examples given above. Alternatively, for example, the sequence of performing the data acquisition processes can be decided with a higher priority given to the display positions than the file types.

The communicating unit 133 performs communication with an external device, and sends and receives a variety of information. For example, the communicating unit 133 issues an acquisition request to the communication node 90, and receives the data sent by the communication node 90. The memory 134 is used to store a variety of information. For example, the memory 134 is used to store the data used in the data processing performed by the general-purpose processor 110.

The transfer unit 135 transfers the processing unit data. More particularly, the transfer unit 135 obtains the bare minimum data to be used for the display purposes by the display 120, that is, obtains the processing unit data from the memory 134; and transfers the obtained data to the general-purpose processor 110. Moreover, at the time of transferring the processing unit data, the transfer unit 135 issues an activation instruction to the general-purpose processor 110 that has switched to the sleep mode. Meanwhile, when the storage information is also present along with the acquisition request and the data-acquisition-method identifiers, the transfer unit 135 stores the processing unit data in a memory of the general-purpose processor 110 according to the storage method indicated in the storage information.

Herein, the processing unit data represents the bare minimum data necessary for displaying a Web page made of HTML files and CSS files. Alternatively, the processing unit data can be data for which a high degree of similarity is found between the host names or the domain names of the files used in analysis, the URLs, and the data-acquisition-method identifiers. Still alternatively, the processing unit data can be data specified in advance in a definition file such as a manifest file. Still alternatively, the processing unit data can be data not included in the examples given above. Based on the processing unit data transferred by the transfer unit 135, the general-purpose processor 110 performs the data processing.

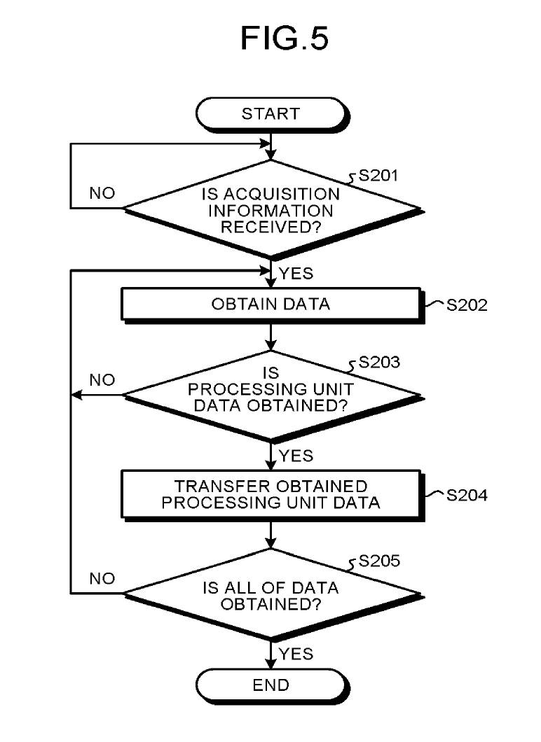

Explained below with reference to FIG. 5 is a sequence of processes performed in the communication device 130 according to the first embodiment. FIG. 5 is a flowchart for explaining an exemplary sequence of processes performed in the communication device 130 according to the first embodiment.

As illustrated in FIG. 5, when the receiving unit 131 receives acquisition information from the general-purpose processor 110 (Yes at Step S201); the obtaining unit 132 obtains, based on the acquisition information, data from the communication node 90 via the communicating unit 133 (Step S202). The obtained data is then stored in the memory 134. Meanwhile, if the acquisition information is not yet received (No at Step S201), then the receiving unit 131 waits for the receipt of the acquisition information.

Then, based on the data stored in the memory 134, the transfer unit 135 determines whether or not the processing unit data has been obtained (Step S203). If it is determined that the processing unit data has been obtained (Yes at Step S203), then the transfer unit 135 transfers the processing unit data to the general-purpose processor 110 (Step S204). However, if the transfer unit 135 determines that the processing unit data is not yet obtained (No at Step S203), then the system control returns to Step S202.

Based on the acquisition information, the obtaining unit 132 determines whether or not all of the data has been obtained (Step S205). If all of the data is not yet received (No at Step S205), then the system control returns to Step S202. When all of the data is received (Yes at Step S205), it marks the end of the processes. According to the first embodiment, the data required by the general-purpose processor 110 is obtained on behalf of the general-purpose processor 110; and, while the data is being obtained, the general-purpose processor 110 is switched to the sleep mode. Hence, it becomes possible to reduce the power consumption. Moreover, every time the processing unit data is obtained, the general-purpose processor 110 is switched back from the sleep mode and the processing unit data is transferred thereto. Then, the general-purpose processor 110 performs the data processing. That enables achieving enhancement in the user-friendliness.

### Second Embodiment

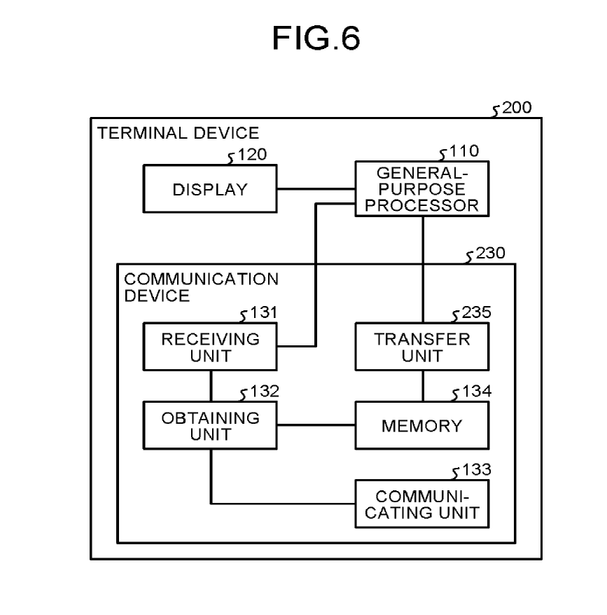

FIG. 6 is a block diagram illustrating an exemplary functional configuration of a terminal device according to a second embodiment. In the second embodiment, the constituent elements having an identical configuration to the first embodiment are referred to by the same reference numerals, and the detailed explanation of those constituent elements is sometimes not repeated. In the second embodiment, except for a transfer unit 235 described below, the functions, the configurations, and the operations of the other constituent elements are identical to the first embodiment.

As illustrated in FIG. 6, a terminal device 200 includes the general-purpose processor 110, the display 120, and a communication device 230. Moreover, the communication device 230 further includes the obtaining unit 132, the communicating unit 133, the memory 134, and the transfer unit 235. Some or all of these constituent elements can be implemented using software (computer programs) or can be implemented using hardware circuitry.

The transfer unit 235 transfers processing unit data containing dummy data. More particularly, if processing unit data is not stored in the memory 134, then the transfer unit 235 replaces the missing data with dummy data and then transfers processing unit data containing the dummy data to the general-purpose processor 110. Thus, in the state in which the obtaining unit 132 is arbitrarily obtaining the data; processing unit data containing dummy data and displayable on the display 120 is transferred in place of the not-yet-obtained data by the transfer unit 235 to the general-purpose processor 110. As a result, the general-purpose processor 110 can update the browser application in a more expeditious manner. Moreover, since the browser application is updated, it becomes possible to shorten the period of time for which the display is stopped. That enables achieving enhancement in the user-friendliness.

After transferring the processing unit data containing dummy data, if the regular data corresponding to the dummy data is obtained by the obtaining unit 132 and stored in the memory 134; then the transfer unit 235 transfers the regular data to the general-purpose processor 110. Consequently, the general-purpose processor 110 replaces the dummy data with the regular data, and then updates the browser application. Meanwhile, as an example of implementing the technique described above, a script file written for changing the display after displaying is completed can be added in advance in an HTML file.

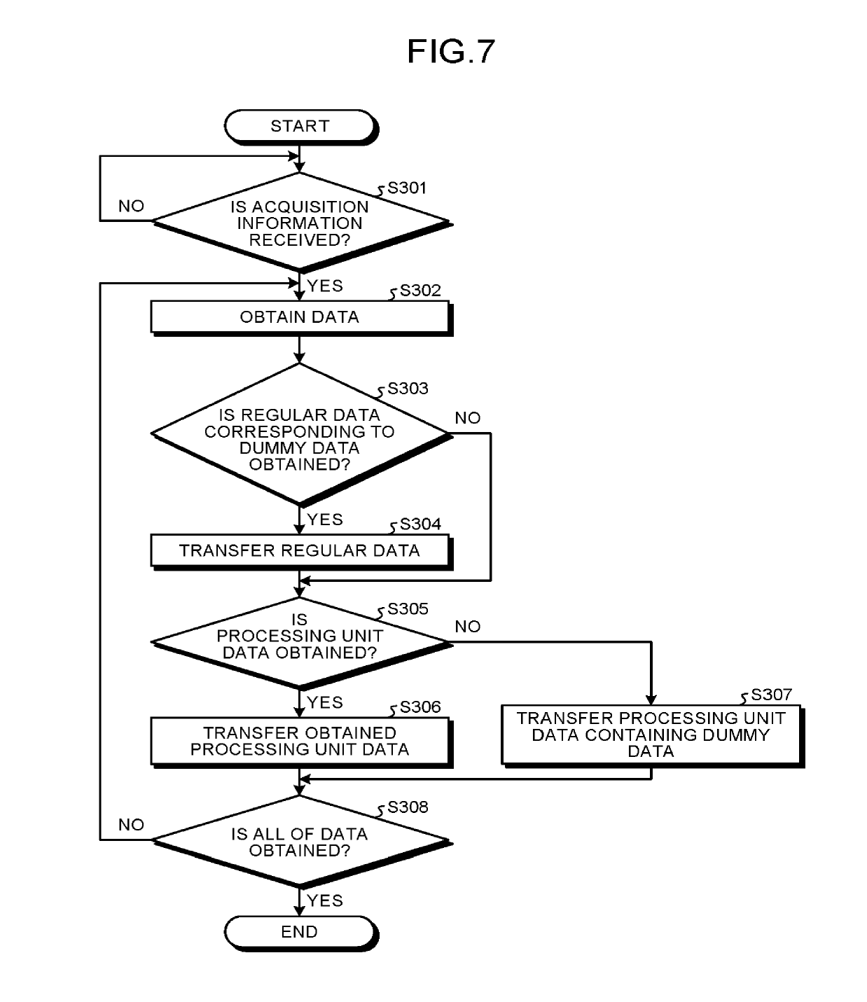

Explained below with reference to FIG. 7 is a sequence of processes performed in the communication device 230 according to the second embodiment. FIG. 7 is a flowchart for explaining an exemplary sequence of processes performed in the communication device 230 according to the second embodiment. With reference to FIG. 7, regarding the processes identical to the processes performed by the communication device 130 according to the first embodiment, the explanation is not repeated. More particularly, the processes performed at Step S301 and Step S302 are identical to the processes performed at Step S201 and Step S202, respectively. Moreover, the processes performed at Step S305, Step S306, and Step S308 are identical to the processes performed at Step S203, Step S204, and Step S205, respectively.

As illustrated in FIG. 7, after the obtaining unit 132 obtains the data, the transfer unit 235 determines whether or not the regular data corresponding to the dummy data has been obtained (Step S303). If it is determined that the regular data has been obtained (Yes at Step S303), then the transfer unit 235 transfers the regular data to the general-purpose processor 110 (Step S304). On the other hand, if the transfer unit 235 determines that the regular data has not been obtained (No at Step S303), the system control proceeds to Step S305. Then, if it is determined that the processing unit data has not been obtained (No at Step S305), the transfer unit 235 transfers processing unit data containing dummy data to the general-purpose processor 110 (Step S307).

According to the second embodiment, if the processing unit data has not been obtained, processing unit data containing dummy data is transferred to the general-purpose processor 110. Hence, the display of the browser application is arbitrarily updated, thereby enabling achieving enhancement in the user-friendliness.

### Third Embodiment

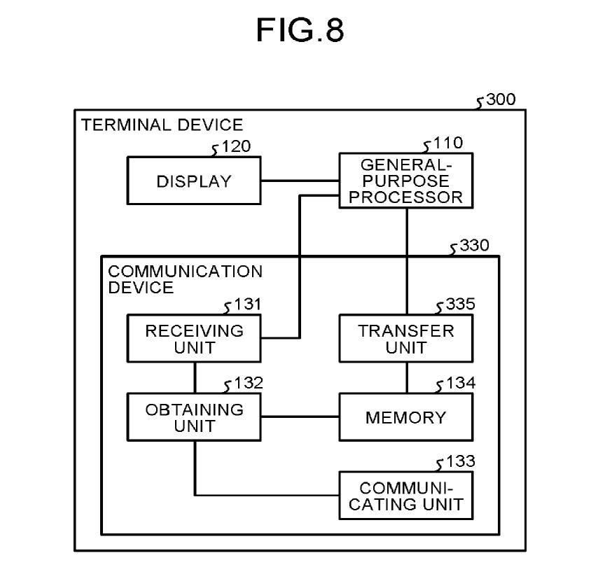

FIG. 8 is a block diagram illustrating an exemplary functional configuration of a terminal device according to a third embodiment. In the third embodiment, the constituent elements having an identical configuration to the first embodiment are referred to by the same reference numerals, and the detailed explanation of those constituent elements is sometimes not repeated. In the third embodiment, except for a transfer unit 335 described below, the functions, the configurations, and the processes of the other constituent elements are identical to the first embodiment.

As illustrated in FIG. 8, a terminal device 300 includes the general-purpose processor 110, the display 120, and a communication device 330. Moreover, the communication device 330 further includes the obtaining unit 132, the communicating unit 133, the memory 134, and the transfer unit 335. Some or all of these constituent elements can be implemented using software (computer programs) or can be implemented using hardware circuitry.

The transfer unit 335 transfers not-yet-transferred processing unit data after each elapse of a predetermined period of time. More particularly, when the receiving unit 131 receives the acquisition information or when a predetermined period of time elapses since the processing unit data is transferred to the general-purpose processor 110, the transfer unit 335 transfers not-yet-transferred processing unit data to the general-purpose processor 110. Thus, in the third embodiment, when a preset timeout period elapses, the processing unit data is arbitrarily transferred. Thus, it becomes possible to curb the occurrence of a situation in which the general-purpose processor 110 does not perform data processing for a long period of time. Moreover, in the case of transferring processing unit data containing dummy data, if a timeout period is set, it becomes possible to reduce the displeasure of the user caused due to the fact that updating of the browser application is late.

Meanwhile, the timeout period can be changed for each instance of transferring the processing unit data, that is, for each instance of switching back the general-purpose processor 110 from the sleep mode. For example, for each instance of transferring the processing unit data, the timeout period is gradually increased. With that, it becomes possible to prevent the general-purpose processor 110 from unintentionally switching back from the sleep state.

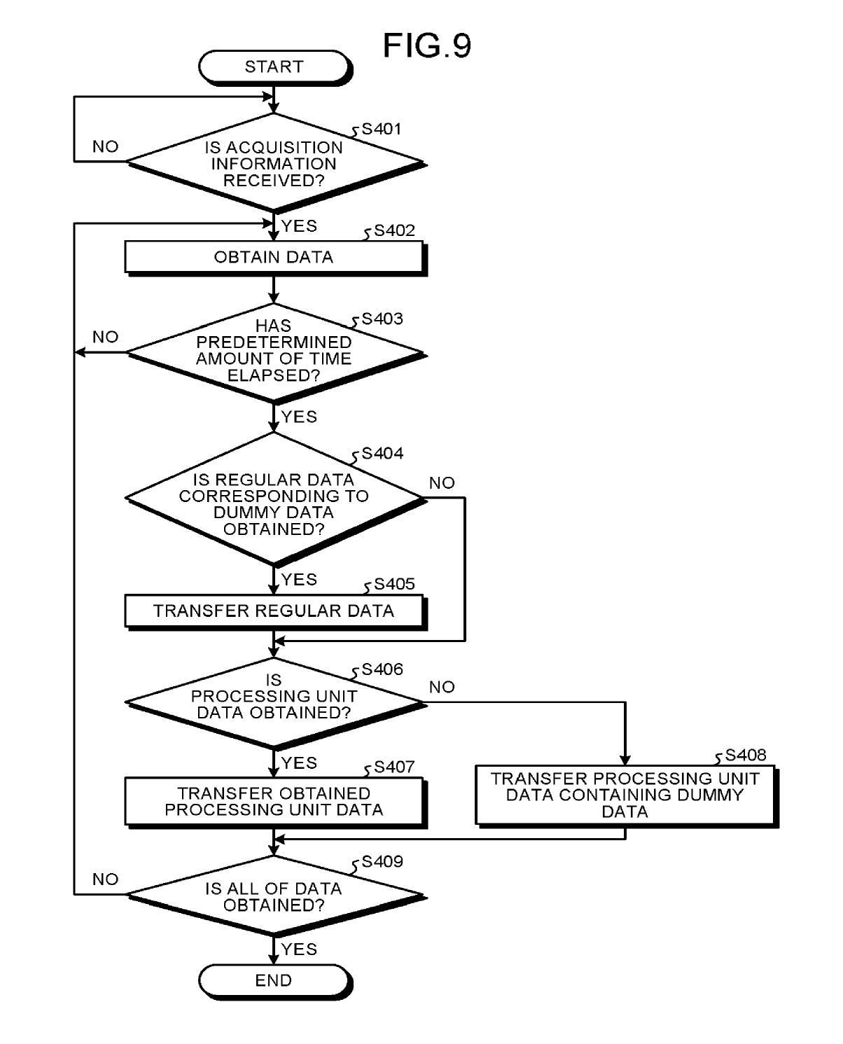

Explained below with reference to FIG. 9 is a sequence of processes performed in the communication device 330 according to the third embodiment. FIG. 9 is a flowchart for explaining an exemplary sequence of processes performed in the communication device 330 according to the third embodiment. With reference to FIG. 9, regarding the processes identical to the processes performed by the communication device 230 according to the second embodiment, the explanation is not repeated. More particularly, the processes performed at Step S401 and Step S402 are identical to the processes performed at Step S301 and Step S302, respectively. Moreover, the processes performed at Step S404 to Step S409 are identical to the processes performed at Step S303 to Step S308, respectively.

As illustrated in FIG. 9, after the obtaining unit 132 obtains data, the transfer unit 335 determines whether or not a predetermined amount of time (a timeout period) has elapsed (Step S403). If the transfer unit 335 determines that the predetermined amount of time has not elapsed (No at Step S403), then the system control proceeds to Step S402. When it is determined that the predetermined amount of time has elapsed (Yes at Step S403), the system control proceeds to Step S404.

According to the third embodiment, the processing unit data is transferred to the general-purpose processor 110 after each elapse of a predetermined amount of time. Hence, it becomes possible to curb the occurrence of a situation in which the browser application is not updated for a long period of time. That enables achieving enhancement in the user-friendliness.

### Fourth Embodiment

Till now, the explanation was given about the embodiments of the terminal device and the communication device. Beyond that, it is also possible to implement various illustrative embodiments. Given below is the explanation of different embodiments regarding (1) transfer of data, (2), data acquisition, (3) extraction of data-acquisition-method identifiers, and (4) configuration.

(1) Transfer of Data

In the embodiments described above, the explanation is given for a case in which the general-purpose processor 110 is switched back from the sleep mode in response to the acquisition of processing unit data or the elapse of a timeout period. Alternatively, regarding transferring the processing unit data, the general-purpose processor 110 can be switched back from the sleep mode after all of the data is obtained, and the processing unit data can be transferred in series. As a result, it becomes possible to hold down an increase in the processing load caused by transferring all of the data at once. Thus, for example, it becomes possible to curb the occurrence of a situation in which the display of the browser application is not updated for a long period of time.

Meanwhile, if it takes time to obtain the processing unit data; then, based on the volume of data and the communication environment, an estimated time can be fed back to the browser application. Thus, the browser application can change the display based on the estimated time and can display the regular data according to the data acquisition.

(2) Data Acquisition

In the embodiments described above, the explanation is given for a case in which the data is obtained from a single communication node 90. However, regarding the destinations for issuing data acquisition requests, it is possible to obtain the data from a plurality of different communication nodes 90. Moreover, in the embodiments described above, the explanation is given for a case in which the data acquisition process is performed for each data-acquisition-method identifier. Alternatively, the data acquisition process can be performed in the following manner. For example, the data acquisition process can be performed by simultaneously establishing connection with a plurality of hosts, or the data acquisition process can be performed by establishing a plurality of connections with a single host.

(3) Extraction of Data-Acquisition-Method Identifiers

In the embodiments described above, the explanation is given for an example in which the data-acquisition-method identifiers embedded in the HTML tags are extracted. Alternatively, the data-acquisition-method identifiers can be extracted in the following manner. For example, it is possible to extract the data-acquisition-method identifiers written in CSS files; or it is possible to extract the data-acquisition-method identifiers written in definition files such as manifest files defined in HTML5; or it is possible to extract the data-acquisition-method identifiers embedded in files that are written in a scripting language. Moreover, it is possible to extract the data-acquisition-method identifiers embedded in HTML data that is automatically generated using a Hypertext Preprocessor (PHP).

(4) Configuration

The processing procedures, the control procedures, specific names, various data, and information including parameters described in the embodiments or illustrated in the drawings can be changed as required unless otherwise specified. The constituent elements of the device illustrated in the drawings are merely conceptual, and need not be physically configured as illustrated. The constituent elements, as a whole or in part, can be separated or integrated either functionally or physically based on various types of loads or use conditions.

For example, the communication device 130 may not be included in the terminal device 100. In that case, the configuration is such that the terminal device 100 including at least the general-purpose processor 110 is connected to the communication device 130. Moreover, for example, the display 120 may not be included in the terminal device 100. In that case, the configuration is such that the terminal device 100 including at least the general-purpose processor 110 is connected to the display 120 that serves as a display device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a receiving unit configured to receive acquisition information, which is sent from a general-purpose processor to a network and which represents information for obtaining data present on the network;
an obtaining unit configured to, based on the received acquisition information, obtain the data on behalf of the general-purpose processor; and
a transfer unit configured to, when processing unit data representing the data to be used in units of processing by the general-purpose processor is obtained, transfer the obtained processing unit data to the general-purpose processor.

2. The device according to claim 1, wherein the transfer unit transfers, as the processing unit data, the data for which a degree of similarity with an acquisition method identifier of the data included in the acquisition information is equal to or greater than a predetermined value to the general-purpose processor.

3. The device according to claim 1, wherein the transfer unit transfers, as the processing unit data, the data specified in a definition file to the general-purpose processor.

4. The device according to claim 1, wherein the transfer unit transfers the processing unit data containing dummy data to the general-purpose processor.

5. The device according to claim 4, wherein, after transferring the processing unit data containing the dummy data, when regular data corresponding to the dummy data is obtained, the transfer unit transfers the obtained regular data to the general-purpose processor.

6. The device according to claim 1, wherein, when the acquisition information is received or when a predetermined period of time elapses since the processing unit data including at least one piece of the data is transferred, the transfer unit transfers not-yet-transferred processing unit data to the general-purpose processor.

7. The communication device according to claim 6, wherein, when the predetermined period of time that changes for each instance of transferring the processing unit data, the transfer unit transfers the not-yet-transferred processing unit data to the general-purpose processor.

8. A communication method comprising:
receiving acquisition information, which is sent from a general-purpose processor to a network and which represents information for obtaining data present on the network;
obtaining, based on the received acquisition information, the data on behalf of the general-purpose processor; and
transferring, when processing unit data representing the data to be used in units of processing by the general-purpose processor is obtained, the obtained processing unit data to the general-purpose processor.

9. A terminal device comprising:
a general-purpose processor configured to output acquisition information which represents information for obtaining data present on a network;
a receiving unit that receives the acquisition information;
an obtaining unit configured to, based on the received acquisition information, obtain the data on behalf of the general-purpose processor; and
a transfer unit configured to, when processing unit data representing the data to be used in units of processing by the general-purpose processor is obtained, transfer the obtained processing unit data to the general-purpose processor, wherein
the general-purpose processor performs processing based on the processing unit data transferred thereto.

10. The terminal device according to claim 9, further comprising a display configured to display information according to processing performed by the general-purpose processor for each piece of the processing unit data.
